(19) United States
(12) Patent Application Publication
(10) Pub. No.: US 2008/0240361 A1
(43) Pub. Date: Oct. 2, 2008

(54) Registering device for registering an object by x-rays as a funtion of a body signal and associated method

(75) Inventor: Klaus Klingenbeck-Regn, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 12/079,611

(22) Filed: Mar. 27, 2008

(30) Foreign Application Priority Data
Mar. 28, 2007 (DE) 10 2007 014 828.5

(51) Int. Cl. H05G 1/00

(52) U.S. Cl. 378/165

(57) ABSTRACT

The invention relates to a registering device for registering an object in at least two dimensions featuring an x-ray transmitter and a detector for the x-rays arranged in a registering plane. The registering device also features a positioning device connected to the detector and the transmitter in such a way that the detector can register x-rays which are transmitted through the object onto the registering plane in differing spatial orientations of the projection axis. The registering device comprises an image reproduction unit to reproduce the data set and an input for a body signal representing an organ movement of the object. The registering device associatively moves the x-ray transmitter or the detector as a function of the body signal so that the projection axis follows the organ movement.

### CROSS REFERENCE TO RELATED APPLICATIONS

This application claims priority of German application No. 10 2007 014 828.5 filed Mar. 28, 2007, which is incorporated by reference herein in its entirety.

### FIELD OF THE INVENTION

The invention relates to a registering device for registering an object in at least two dimensions.

### BACKGROUND OF THE INVENTION

In the case of the x-ray appliances which are known from the prior art for registering an object during an intervention—in-vivo—the problem often occurs that an organ, at which an intervention is to take place, moves. It is therefore often difficult to compare the moving object with a previously made recording of the object.

### SUMMARY OF THE INVENTION

The invention addresses the problem of specifying an improved x-ray device which simplifies an observation of a moving object—in vivo—by means of x-rays.

This problem is solved by a registering device. The registering device features an x-ray transmitter for emitting x-rays and a detector for the x-rays, wherein said detector is arranged in a registering plane and can generate at least one 2D data set which represents the object in a projection through the object. The registering device also features a positioning device, wherein the detector and the transmitter are connected in each case to the positioning device, wherein the positioning device is designed to arrange the x-ray transmitter and/or the detector in such a way that the detector can register x-rays which are transmitted through the object onto the registering plane in differing spatial orientations of the projection axis, and the registering device features an image reproduction unit and is designed to reproduce at least the 2D data set by means of the image reproduction unit. The registering device features at least one input for a body signal which represents an organ movement of an organ of the object. The registering device is designed, by means of the positioning device, to associatively move the x-ray transmitter and/or the detector as a function of the body signal in such a manner that the projection axis follows the organ movement. By virtue of such a registering device, it is advantageously possible to simplify a comparison of an organ which is registered by means of x-rays—in particular in-vivo—with previously registered registration results of corresponding anatomical regions.

The projection axis is preferably arranged perpendicular to the detector. The projection axis therefore corresponds to a “viewing direction” of the detector.

The registering device preferably features a processing unit which is connected to the input for the body signal on the input side and is connected to the positioning device on the output side and is designed to evaluate the body signal and generate a control signal as a function of the body signal, wherein said control signal represents a spatial orientation of the projection axis, and to transit said control signal to the positioning device. Moreover, the processing unit can preferably feature a signal form analyzer which can evaluate a signal form of the body signal.

In a preferred embodiment, the body signal is a heart activity signal which represents a heart activity. In this embodiment, the registering device preferably features an input for a heart activity signal. The input for the heart activity signal is intended for connection to an ECG sensor (ECG=electrocardiogram). A heart activity signal can be registered e.g. using a multipoint derivation, in particular a three-point derivation, which is known from the prior art. The registering device can preferably feature an ECG sensor which is designed to register a heart activity and generate a heart activity signal that corresponds to the heart activity.

In a preferred embodiment, the body signal is a respiration signal representing a breathing activity. In this embodiment, the registering device advantageously features an input for the respiration signal. In addition, the processing unit is preferably connected to the input for the respiration signal and/or to the input for the heart activity signal.

The registering device preferably features a respiration sensor which is designed to register a breathing activity, generate a respiration signal that represents the breathing activity, and output said respiration signal on the output side. The respiration sensor is preferably connected on the output side to the input for the respiration signal. As a result, it is advantageously possible to register a local displacement and/or an elastic deformation of an object, e.g. a heart, due to a breathing activity.

In a further preferred embodiment, the respiration sensor is designed to generate the respiration signal as a function of a heart activity signal which represents a heart activity. As a result, it is advantageously possible to register heart activity and respiration simultaneously using a small number of electrodes. Using a sensor for registering an electrocardiogram, which corresponds to a heart activity signal, it is advantageously possible to carry out a 3D registration as a function of a further dimension, specifically as a function of the heart activity signal.

For example, the respiration sensor can advantageously generate the respiration signal as a function of a heart activity signal form, in particular as a function of a QT interval, an R-R interval or a Q-R-S interval. For this, the respiration sensor can feature a signal form analyzer which is designed to register periodically recurring signal sections of a heart activity signal. A signal form analyzer can comprise e.g. at least one sample-and-hold element and a memory unit which is connected to the sample-and-hold element for the purpose of storing sampled signal amplitude values.

In an advantageous embodiment, the respiration sensor is designed to register a thoraxial impedance and to generate a respiration signal which represents the thoraxial impedance. The respiration sensor can comprise at least two electrodes, for example, which are intended to be arranged at a thorax. The respiration sensor preferably features a current source which is to be connected to the electrodes, wherein the current source is designed to generate temporally consecutive alternating currents having different frequencies in each case, e.g. in the region from 500 Hertz to 100 thousand Hertz. The respiration sensor can also preferably feature a voltage registration unit and a current registration unit, each of which is connected to a quotient element. The quotient element is designed to form a quotient from registered voltage and registered current. The quotient element can generate a quotient signal, wherein the quotient signal corresponds to the formed quotient and represents the registered thoraxial impedance.

Alternatively, a respiration sensor can be designed to register a change of a thorax circumference. For this, the respiration sensor can feature a belt for surrounding a thorax, wherein the belt is connected to an extensometer. The extensometer is designed to change its electrical properties, in particular its electrical resistance, as a function of a deformation of the extensometer.

Using the respiration sensor, it is advantageously possible to register a thoraxial movement which is dependent on breathing and an elastic deformation, this being associated with the thoraxial movement, of objects which must be registered, e.g. organs. A sequence of 2D data sets which are registered as a function of a respiration signal can preferably be formed over a time period which comprises at least an inhalation phase, an exhalation phase or both phases.

In an advantageous embodiment, the registering device features an input for a location signal which forms the body signal. The location signal represents a spatial location of an instrument which is provided for invasive introduction into the object, in particular a person. For this, the registering device can feature a location sensor which can optically or magnetically register a location of the instrument. The location signal can represent location coordinates, for example. The registering device can control the positioning device as a function of the location signal.

In a further embodiment, the location sensor is an ultrasound location sensor which is designed, by means of two separate ultrasound transmitters that are connected to the instrument and three ultrasound receivers e.g. electret condenser microphones that are spatially separate from the ultrasound transmitters, to register a spatial instrument location of the medical instrument as a function of a propagation time difference of ultrasound signals which are generated by the ultrasound transmitters, and to generate a corresponding instrument data set which represents the instrument location.

In a further embodiment, the location sensor is designed to register a spatial orientation of a magnetizable or permanently magnetic object, in particular from two and preferably from three different registration directions, and depending on the spatial orientation of the magnetizable or permanently magnetic object, to register a spatial location of the magnetizable or permanently magnetic object. The magnetizable or permanently magnetic object can be connected to a medical instrument, for example, in particular in the region of a catheter end or in the region of an end of a guide wire or of another medical or surgical instrument. In this embodiment, the location sensor is designed to generate a location signal which represents the location of the magnetizable or permanently magnetic object.

In a further embodiment, the location sensor is an optical location sensor which, by means of electromagnetic rays that are in particular in the infrared wavelength range, can register an instrument location of the instrument in particular interferometrically and can generate a location signal which represents the instrument location.

In a preferred embodiment, the registering device features an object memory for holding an object data set. The object data set represents the object in at least three dimensions. In this embodiment, the registering device is designed to generate an image data set from at least a part of the object data set, wherein said image data set represents the object (in particular in a plan view, a phantom view or a section through the object), and to reproduce the image data set in combination with the 2D data set by means of an image reproduction unit. In this way, during an intervention, an image data set which represents the object in a predefined registration direction, e.g. observes a plan view, a phantom view or a section from a predefined direction, can be reproduced in combination with a temporal sequence of 2D data sets which represent the in-vivo registered object. It is also advantageous that, by means of the positioning device which is designed for the purpose of tracking, the projection axis can track the object movement, such that the observation section and/or an observation direction of the in-vivo registered object remains virtually unchanged.

The registering device preferably features a calibrating device which is designed to generate, on the basis of the object data set, an image data set with an observation direction that corresponds to at least one orientation of the projection axis and hence an observation section and/of an observation direction of the in-vivo registered object. In a further embodiment—or in addition to the above described embodiment—the registering device, and e.g. processing unit there, can generate a positioning signal such that the projection axis for generating the 2D data sets corresponds to an observation direction of the image data set which is generated from the object data set. For this, the registering device can be designed to determine the observation direction from the image data set, or to store the spatial orientation of the observation direction e.g. in the form of an observation direction data set when the image data set is generated—e.g. by means of volume rendering—from the object data set.

In a preferred embodiment, the registering device features an assignment unit which is designed to assign a 2D data set from a sequence of 2D data sets to at least a part of the object data set as a function of a similarity parameter, and to output said 2D data set for reproduction in combination with an image data set which is generated from the object data set. The assignment unit is preferably designed to perform an assignment by means of a cross correlation. As a result of an assignment as a function of a similarity parameter, a calibration of the positioning device is advantageously simplified. It is also advantageous that post-calibration of the positioning device following an object movement can be omitted.

The registering device preferably features a movement pattern memory which can store a movement pattern of the organ movement—e.g. in the form of a sequence of coordinates or a spline curve. Furthermore, the processing unit can be designed to evaluate the body signal and to synchronize the organ movement with the body signal.

The positioning device can preferably feature an electronic drive, a pneumatic drive or a hydraulic drive or a combination of these. The drive can be designed such that it can follow at least half of a breathing and/or heartbeat period. A heartbeat period can be e.g. up to 200 heartbeats per minute.

The invention also relates to a method for registering an object in at least two dimensions, wherein x-rays are transmitted through the object in a projection axis onto a registering plane and registered there. The method provides for generating at least one 2D data set which represents the object in a projection through the object, and the at least one 2D data set is reproduced by means of an image reproduction unit. The method inventively provides for registering an organ movement of an organ of the object and generating a body signal which represents the organ movement, and for a spatial orientation of the projection axis to track the organ movement as a function of the body signal.

The body signal is preferably a respiration signal and/or a heart activity signal. The at least one 2D data set is preferably reproduced in combination with an image data set by means of an image reproduction unit. The image data set is generated from an object data set, which has been previously registered in particular, wherein the object data set represents the object at least partially in at least three dimensions.

### BRIEF DESCRIPTION OF THE DRAWINGS

The invention is explained below with reference to figures and further exemplary embodiments.

FIG. 1 shows an exemplary embodiment of a registering device for registering an object in at least two dimensions by means of x-rays;

FIG. 2 shows an exemplary embodiment of a positioning device for the registering device which is illustrated in FIG. 1;

FIG. 3 shows an exemplary embodiment of a method for registering an object by means of x-rays.

### DETAILED DESCRIPTION OF THE INVENTION

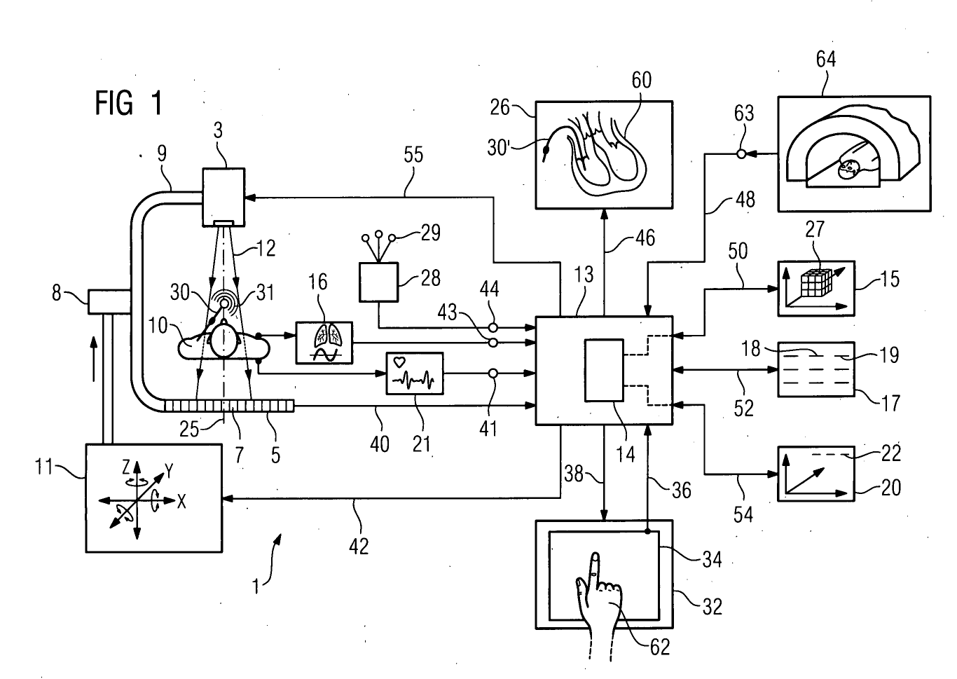

FIG. 1 schematically shows an exemplary embodiment of a registering device 1 having an x-ray transmitter 3 and a detector 5. The detector 5 features a multiplicity of detector matrix elements, of which the detector matrix element 7 is designated by way of example. The x-ray transmitter 3 is connected to the detector 5 by means of a C-arm 9, such that an object 10 can be registered by means of x-rays 12, these being generated by the x-ray transmitter 3, along a projection axis 25 in a projection through the object 10 and onto the detector 5. The C-arm 9 is pivotably mounted and can be pivoted in three rotatory degrees of freedom, in particular about an axis X, an axis Y or an axis Z. The axes X, Y and Z together form an orthogonal system. The C-arm can also be moved in three translational degrees of freedom, in particular parallel with the axis X, parallel with the axis Y or parallel with the axis Z. For this, the C-arm 9 is connected to a positioning device 11 by means of a servomechanism 8, such that the C-arm 9 can be moved in a rotatory and/or translational manner. For this, the positioning device is designed to move the C-arm 9, as a function of an actuating signal which is received on the input side, by means of the servomechanism 8 into a registration position which is represented by the actuating signal and corresponds to the body signal and hence to an organ orientation. The detector 5 can generate a sequence of 2D data sets in the registration position.

Independently of the C-arm which is illustrated in FIG. 1, the positioning device 11 can be separately connected in each case to the detector and the x-ray transmitter 3 and move these independently of each other.

The detector matrix elements 7 of the detector 5 are designed in each case to receive x-rays 12 and, as a function of the received x-rays 12, to generate a detector matrix element signal which represents a ray intensity of the received x-ray 12. The detector matrix elements 7 can in each case feature selenium or silicon, in particular amorphous silicon. The registering device 1 also features a processing unit 13. The processing unit 13 features an assignment unit 14. The registering device 1 also features a memory 15 and a memory 17. The memory 15 is designed for holding 3D data sets, of which the 3D data set 27 is illustrated by way of example. The memory 17 is designed for holding at least one 2D data set, of which the 2D data set 19 is designated by way of example.

The registering device 1 also features a coordinate memory 20 which is designed for holding an object-coordinate data set, wherein the object-coordinate data set 22 is designated by way of example. The memory 15, the memory 17 and the memory 20 can be realized together by means of a combined memory. The memories 15, 17, 20 and 25 are designed in each case as write/read memories, in particular as non-volatile write/read memories.

The registering device 1 also features an input 63 for an object data set. Connected to the input 63 is a registering device 64 for registering an object in at least three dimensions. The registering device 64 can be a computer tomograph, a single-photon-emission computer tomograph (SPECT), a magnetic resonance tomograph (MRT), a Doppler sonograph, in particular a color-coded duplex sonograph, or a positron-emission tomograph (PET) which can in each case generate an object data set, subsequently also referred to as a 3D data set. The 3D data set 27 can represent a multiplicity of voxel object points, which together represent the object 10 in at least three dimensions. In this case, three dimensions are spatial and further dimensions e.g. temporal.

The registering device 1 also features an image reproduction unit 26. The registering device 1 also features an input unit 32 with a touch-sensitive surface 34. The input unit 32 in this embodiment features an image reproduction unit with the touch-sensitive surface 34. The touch-sensitive surface 34 is designed to generate a user interaction signal as a function of a touch by a user hand 62, which signal represents the location of the touching of the touch-sensitive surface 34, and to output said signal on the output side.

The registering device 1 also features a location sensor 28. The location sensor 28 features at least one antenna 29, which is designed to register an electromagnetic field 31 of the medical instrument 30. The medical instrument 30 is designed to generate the electromagnetic field 31. The location sensor 28 is designed to generate a location signal as a function of the registered electromagnetic field 31, which signal represents the instrument location of the instrument 30, in particular a catheter section or a catheter end which is intended for introduction into an organ, and to output said signal on the output side. The catheter can feature a magnetizable element at the instrument location, wherein said element can be registered by the location sensor 28.

The touch-sensitive surface 34 is connected on its output side via a connection line 36 to the central processing unit 13. The processing unit 13 is connected via a connection line 38 to the input unit 32 and there to the image reproduction unit of the input unit 32. The detector 5 is connected on its output side via a connection line 40 to the central processing unit 13. The processing unit 13 is connected on its output side via a connection line 42 to the positioning device 11. The processing unit 13 is connected on its input side via a connection line 44 to the location sensor 28, via a connection line 46 to the image reproduction unit 26, via a connection line 48 to the input 63, via a connection line 50 to the memory unit 15, via a connection line 52 to the memory unit 17 and via a connection line 54 to the coordinate memory 20.

The registering device also features an input 43 for a respiration signal, an input 41 for a heart activity signal and an input 44 for an instrument data set. The processing unit 13 is connected on its input side to the input 41, to the input 43 and to the input 44.

The input 43 is connected to a respiration sensor 16. The respiration sensor 16 is designed to register a thoraxial impedance which represents an organ movement that is dependent on breathing. The organ movement can be a direct movement of the lungs, or an indirect organ movement of an abdominal organ, e.g. the pancreas, as a function of the breathing. The respiration sensor comprises e.g. at least two electrodes for registering the thoraxial impedance. The processing unit 13 is connected on the input side to the input 43.

Connected to the input 41 for a heart activity signal is an ECG registering device (21) (ECG=electrocardiogram). The ECG registering device (21) features electrodes for the electrical connection to the object 10, and is designed to register a heart activity and to generate a heart activity signal which represents the heart activity. The connection lines 50, 51, 52 or 54 are bidirectional in each case and can take the form of a data bus in each case.

The functionality of the registering device 1 is now explained below:

The processing unit 13 is designed to generate, as a function of a user interaction signal which is received on the input side via the connection line 36, a control signal for generating the x-ray 12 by means of the x-ray transmitter 3 and to output said control signal via the connection line 55. The control signal for generating the x-ray 12 can represent e.g. an acceleration voltage, an irradiation time, or an electrical charge quantity which generates the x-rays 12. The detector 5 can register the x-rays 12 which are generated by the x-ray transmitter 3 through the object 10 in a projection onto a registering plane in which the detector 5 is arranged, and generate at least one 2D data set or a temporal sequence of 2D data sets which in each case represent the object 10 in one projection through the object 10 onto the registering plane. In this case, the at least one 2D data set represents in each case a 2D matrix of matrix elements which represent in each case an intensity value that corresponds to the correspondingly assigned detector matrix element signal of a detector matrix element.

The processing unit 13 can receive the at least one 2D data set or the 2D data sets via the connection line 40 on its input side and store them in the memory 17 via the connection line 52. The 2D data set 19 is designated there by way of example.

The processing unit 13 can, for the purpose of generating further temporally sequential 2D data sets, as a function of the body signal and in particular the heart activity signal and/or the respiration signal, generate an actuating signal which represents a registration position and transmit this on the output side via the connection line 42 to the positioning device 11. The positioning device 11 can, as a function of the actuating signal, move the C-arm 9 together with the detector 5 and the x-ray transmitter 3 around the object 10—according to the three rotatory and the three translational degrees of freedom—into the registration position which corresponds to the actuating signal and in which the 2D data sets are generated. The 2D data sets therefore represent the object 10 in each case in a registration direction which is dependent on the body signal.

During a further course of intervention, the C-arm 9 follows in further registration positions corresponding to the body signal as described above. The processing unit 13 can then receive the at least one 2D data set or the temporal sequence of 2D data sets via the connection line 40 and store them in the memory 17 via die connection line 52. In this way, the processing unit 13 can generate a plurality of 2D data sets which represent in each case the object 10 in a projection through the object onto a registering plane with a registration direction which corresponds to the body signal in each case. It is thus possible at least approximately to compensate for an organ movement, such that the organ—represented by the temporally sequential 2D data sets—appears to be registered quasi statically from the same direction.

The processing unit 13 can now—e.g. as a function of a user interaction signal which is received via the connection line 36—read out the 2D data sets from the memory 17 via the connection line 52 and transmit them to the image reproduction unit 26 via the connection line 46.

The registering device 1 can receive an object data set, subsequently also referred to as 3D data set, from the input 63, which data set was generated e.g. prior to intervention and represents the object 10 in three dimensions. The 3D data set can be received by the central processing unit 13 via the connection line 48. The 3D data set 27 can represent a multiplicity of voxel object points which, in the case of a registering device 64 having the form of a computer tomograph, represent in each case a value of an absorption coefficient for x-rays at an object location and hence together represent the object 10 in three dimensions. The processing unit 13 can store the 3D data set 27 which is received via the connection line 48 in the memory 17 via the connection line 52. The 3D data set 27 is designated there by way of example. The processing unit 13 can receive an instrument data set on its input side via the connection line 44, wherein said instrument data set represents an instrument location of the instrument 30. In this exemplary embodiment, the instrument 30 is arranged within the object 10. The processing unit 13 can, e.g. for the purpose of calibrating the registering device 1, receive an instrument data set via the connection line 44 and generate at least one object-coordinate data set representing a registration location of the 3D data set, and transmit this via the connection line 44 to the coordinate memory 20 and store it there. The object-coordinate data set 22 is designated by way of example and represents either at least two registration locations, each for one voxel of the 3D data set, or one registration location for one voxel and one spatial orientation, e.g. in the form of a vector, which represents a spatial orientation of the 3D data set.

The registering device 1 can, e.g. for the purpose of increasing an image contrast at a registration position—in-vivo—generate a 2D data set or a temporal sequence of 2D data sets. The registering device can, e.g. by means of the central processing unit 13, generate an angio-2D data set which represents a vascular system of the registered object 10. For this, the processing unit 13 can subtract at least two 2D data sets from each other for each registration location, in particular for each matrix element of a matrix which is represented by the 2D data set, and generate the angio-2D data set as a subtraction result. The angio-2D data set 18 is designated by way of example. In this way the registering device can increase an image contrast which is generated by means of a contrast means.

During an intervention the processing unit, in particular an assignment unit 14, can assign an instrument data set which is received via the connection line 44 to an object location that is represented by a part of the 3D data set, and generate an assignment result which corresponds to the instrument location within the volume that is represented by the 3D data set. The processing unit 13 can, e.g. by means of the assignment result which is generated by the assignment unit 14, generate an image data set which represents the object 10, in particular e.g. a heart 60 of the object 10, in three dimensions together with the instrument 30.

During a further course of intervention, the processing unit 13 can generate a temporal sequence of 2D data sets—or angio-2D data sets—and receive them via the connection line 40, hold them in the memory 17, and read them out again for combined reproduction with the image data set by means of the image reproduction unit 26. The image reproduction unit 26 reproduces the heart 60 and the instrument 30′ by way of example. The heart 60 has been registered as a function of the body signal and is therefore reproduced in temporally consecutive compensating registration directions which at least partially compensate for the organ movement that is represented by the body signal. The processing unit 13 can generate the actuating signals for moving the positioning device 11 such that the compensating registration directions correspond to a registration direction of an image data set that is generated from the object data set. The image data set can represent the object e.g. in a plan view, a phantom view or a section through the object with a corresponding registration direction. The processing unit 13 can generate the image data set from the object data set and transmit it with the 2D data sets to the image reproduction unit 26. During an intervention, the registration direction of the image data set which represents the object prior to intervention can at least approximately match the compensating registration directions.

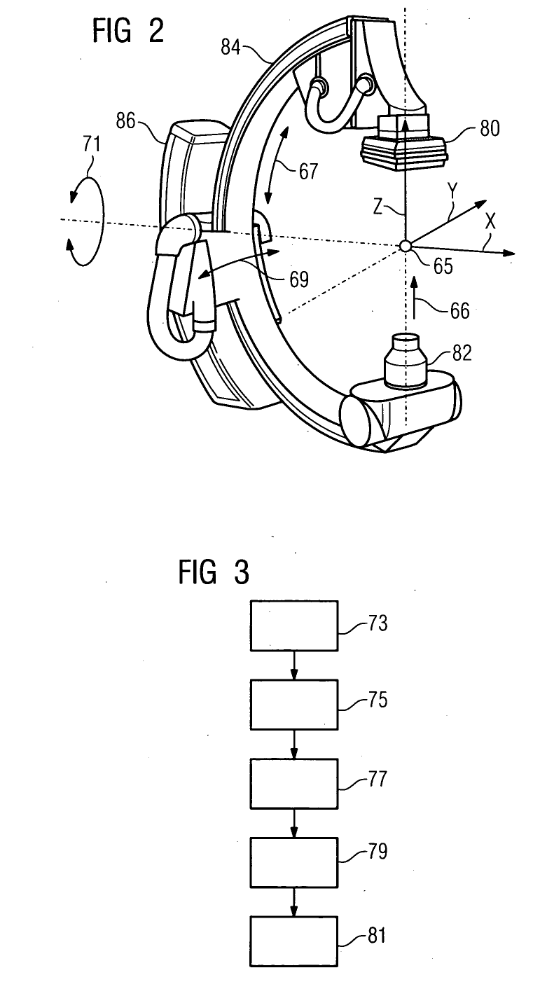

FIG. 2 schematically shows an exemplary embodiment of a C-arm 84 which can be part of the registering device 1 instead of the C-arm 9 which is illustrated in FIG. 1. The C-arm 84 is at least indirectly connected to a positioning device 86. The C-arm 84 features an x-ray transmitter 82 and a detector 80. The x-ray transmitter 82 is arranged in the region of a first end of the C-arm 84 and the detector 80 is arranged in the region of a second end of the C-arm 84 such that an object which is arranged in the region of an isocenter 65—e.g. the object 10 which is illustrated in FIG. 1—can be penetrated by radiation by means of an x-ray which is emitted by the x-ray transmitter 82 along a registration direction 66.

The detector 80 is arranged and configured such that it receives the x-ray which is emitted by the x-ray transmitter 82. The C-arm 84 is designed to execute a translational movement along a longitudinal axis Y, along a lateral axis X, or along a vertical axis Z, or along a combination of these translational axes, as guided by the positioning device 86.

The C-arm 84 is also designed to execute a pivoting movement along a rotatory degree of freedom 67, along a rotatory degree of freedom 69 or along a rotatory degree of freedom 71, as guided by the positioning device 86. In this case, a rotational movement of the C-arm 84 in the rotatory degree of freedom 67 or in the rotatory degree of freedom 69 takes place about an axis of rotation which passes through the isocenter 65.

FIG. 3 shows an exemplary embodiment of a method for registering an object by means of x-rays in up to three dimensions. According to the method, an object is registered in-vivo in a first step 73 and a sequence of 2D data sets representing in each case the object in a phantom view is generated in a further step 75. In a further step 77, an organ movement of an organ of the object is registered and a body signal representing the organ movement is generated. In a step 79, a spatial orientation of the registration direction tracks the organ movement as a function of the body signal. The body signal can be a respiration signal and/or a heart activity signal. In a further step 81, the 2D data set is reproduced together with an image data set by means of an image reproduction unit. The image data set is generated from an object data set which was registered prior to intervention, wherein the object data set represents the object at least partially in at least three dimensions.

1.-11. (canceled)

12. A device for registering an object in a medical examination, comprising:
an x-ray transmitter that emits x-rays;
a detector arranged in a registering plane that generates a 2D data set representing the object in a projection and registers the x-rays onto the registering plane in a plurality of different spatial orientations of a projection axis;
a positioning device connected to the detector and the transmitter; and
an input device connected to the positioning device that inputs a body signal representing an organ movement of the object,
wherein the positioning device is configured to move the x-ray transmitter or the detector as a function of the body signal so that the projection axis follows the organ movement.

13. The device as claimed in claim 12, wherein the body signal is selected from the group consisting of: a heart activity signal, a respiration signal, and a location signal of an instrument.

14. The registering device as claimed in claim 13, wherein the respiration signal represents a thoraxial impedance and is detected by a respiration sensor.

15. The registering device as claimed in claim 13, wherein the location signal of the instrument is detected by a location sensor.

16. The device as claimed in claim 12, further comprising an image reproduction unit that generates an image data set from a 3D data set of the object and reproduces the image data set by combining the image data set with the 2D data set.

17. The device as claimed in claim 16, wherein the image data set represents the object in a plan view, a phantom view, or a section.

18. The device as claimed in claim 16, further comprising an assignment unit that assigns the 2D data set to the 3D data set as a function of a similarity parameter and outputs the 2D data set to the image reproduction unit for the reproduction.

19. A method for registering an object in a medical examination, comprising:
transmitting x-rays through the object along a projection axis to a registering plane;
registering the x-rays onto the registering plane;
generating a 2D data set of the object representing the object in a projection through the object based on the registration of the x-rays;
registering an organ movement of the object;
generating a body signal representing the organ movement; and
tracking the organ movement by adjusting a spatial orientation of a projection axis as a function of the body signal.

20. The method as claimed in claim 19, wherein the body signal is selected from the group consisting of: a heart activity signal, a respiration signal, and a location signal of an instrument.

21. The method as claimed in claim 19, wherein an image data set is generated from a 3D data set of the object and is reproduced by combining the image data set with the 2D data set.

22. The method as claimed in claim 21, wherein the 3D data set is previously registered.
